(19) United States
(12) Patent Application Publication
(10) Pub. No.: US 2016/0006895 A1
(43) Pub. Date: Jan. 7, 2016

(54) IMAGE FORMING APPARATUS, CONTROL METHOD FOR THE IMAGE FORMING APPARATUS AND MEDIUM

(71) Applicant: CANON KABUSHIKI KAISHA, Tokyo (JP)

(72) Inventor: Atsushi Hikichi, Saitama-shi (JP)

(21) Appl. No.: 14/746,685

(22) Filed: Jun. 22, 2015

(30) Foreign Application Priority Data
Jul. 3, 2014 (JP) 2014-138020

(51) Int. Cl. H04N 1/00; G06F 1/32

(52) U.S. Cl. CPC H04N 1/00896; G06F 1/3284; G06F 1/3293; H04N 1/00891; H04N 1/00904; H04N 1/00477; H04N 1/00352; H04N 1/00933; H04N 2201/0094

(57) ABSTRACT

When additional power transition reservation is tried to be set while power transition reservation has been set in an image forming apparatus, the power transition reservation of the image forming apparatus is confirmed, and, if it is judged that power consumption unnecessarily increases, the additional power transition reservation is not set.

### BACKGROUND OF THE INVENTION

1. Field of the Invention

The present invention relates to an image forming apparatus, a control method for the image forming apparatus and a non-transitory computer readable medium which has stored therein a program.

2. Description of the Related Art

In accordance with improvement of a power saving function of an image forming apparatus, the image forming apparatus becomes capable of implementing a function of making a state of the image forming apparatus transition to a sleep state or a shutdown state at time designated by a user or when the user does not use the image forming apparatus for a given period of time. Japanese Patent Laid-Open No. 8-297442 discloses an image forming apparatus for which a standby period and a shutdown period can be set, and in which a state transitions to a standby state during the standby period and the state transitions to a shutdown state during the shutdown period. Further, it is also possible to set time or a timer relating to power transition from outside of the image forming apparatus as well as set time or a timer relating to power transition inside the image forming apparatus.

However, if time or a timer relating to power transition has been already set inside the image forming apparatus, when the time or the timer relating to power transition is set from the outside of the image forming apparatus, there is a case where such setting is useless for the device, and power is wasted.

For example, there is a case where the apparatus tries to return to a normal state from a sleep state although the apparatus cannot perform printing. If a set auto-shutdown time expires within a short period of time, even if the image forming apparatus capable of performing printing at high speed receives notification of transition to a standby state from outside of the image forming apparatus, it may take time to return to the standby state, and the apparatus may be shut down substantially at the same time as returning to the standby state, which results in wasting power for returning to the standby state.

Further, for example, the image forming apparatus which has been already put into a sleep state may waste power by transitioning to the sleep state after being put into a standby state once, when the sleep state is newly set from the outside of the image forming apparatus. Specifically, during a period from the set time for automatically transitioning to a sleep state until time for returning from the sleep state, the device is put into a sleep state. If the sleep time is set from the outside of the image forming apparatus during this period, the image forming apparatus returns to a standby state by interruption of alarm service (RTC: Real Time Clock) in order to transition to the sleep state. Subsequently, this standby state continues for several tens of minutes by a device protection timer, and then, the image forming apparatus is put into a sleep state again. As a result, power is wasted by time for returning from a sleep state being set.

### SUMMARY OF THE INVENTION

The present invention has been made to solve the above-described problem and has the following features.

According to a first aspect of the present invention, there is provide an image forming apparatus comprising: a power control unit that controls power supply to be at any of a first power state, a second power state in which power consumption is lower than in the first power state, and a third power state in which power consumption is lower than in the second power state; a setting unit that sets a timing for transition to any of the first power state, the second power state and the third power state; and a holding unit that holds the transition to the power state and the timing set by the setting unit, wherein the power control unit controls power supply according to the transition to the power state and the timing held by the holding unit, and the setting unit determines whether or not power consumption increases in a case where the transition to the power state and the timing set by the setting unit is additionally set to the transition to the power state and the timing held by the holding unit, and, if the setting unit determines that the power consumption increases, the holding unit does not hold the transition to the power state and the timing to be additionally set, while if the setting unit determines that the power consumption does not increase, the holding unit holds the transition to the power state and the timing to be additionally set.

According to a second aspect of the present invention, there is provided an image forming apparatus comprising: a power control unit that controls power supply to be at any of a first power state, a second power state in which power consumption is lower than in the first power state, and a third power state in which power consumption is lower than in the second power state; a setting unit that sets a timing for transition to any of the first power state, the second power state and the third power state; and a holding unit that holds the transition to the power state and the timing set by the setting unit, wherein the power control unit controls power supply according to the transition to the power state and the timing held by the holding unit, and in a case where a timing for transition to the third power state is held by the holding unit, a timing for transition to the first power state is newly set by the setting unit, and the timing for transition to the first power state is between the timing for transition to the third power state and a timing earlier than the timing for transition to the first power state by a predetermined period, the newly set timing for transition to the first power state is not held by the holding unit.

According to a third aspect of the present invention, there is provided an image forming apparatus comprising: a power control unit that controls power supply to be at any of a first power state, a second power state in which power consumption is lower than in the first power state, and a third power state in which power consumption is lower than in the second power state, a setting unit that sets a timing for transition to any of the first power state, the second power state and the third power state; and a holding unit that holds the transition to the power state and the timing set by the setting unit, wherein the power control unit controls power supply according to the transition to the power state and the timing held by the holding unit, and in a case where a timing for transition to the second power state and a timing for transition to the first power state after the timing for transition to the second power state are held by the holding unit, and transition to the second power state is set between the held timing for transition to the second power state and timing for transition to the first power state by the setting unit, the transition to the second power state and the timing are not held by the holding unit.

According to the present invention, when time or a timer for transition to each state is set from outside of the image forming apparatus, because the time or the timer for transition to each state inside the image forming apparatus is confirmed, and the setting is disabled if power consumption increases, it is possible to reduce power consumption.

Further features of the present invention will become apparent from the following description of exemplary embodiments with reference to the attached drawings.

### BRIEF DESCRIPTION OF THE DRAWINGS

FIG. 1 is a block diagram for explaining a structure of an image forming system;

FIG. 2 is a plan view for explaining a structure of an operating unit;

FIG. 3 is a block diagram for explaining a structure of a controller;

FIG. 4 is a block diagram for explaining a structure of the controller;

FIG. 5 is a block diagram for explaining a structure of power supplies of an image forming apparatus;

FIG. 6 illustrates screen display for explaining a display method for the image forming apparatus;

FIG. 7 is a timing chart for explaining a control method for the image forming apparatus when a problem occurs;

FIG. 8 is a timing chart for explaining the control method for the image forming apparatus;

FIG. 9 is a table for explaining a device activation period including a heat-up period of each of devices constituting the image forming apparatus;

FIG. 10 is a table for explaining a connection state of the devices constituting the image forming apparatus;

FIG. 11 is a flowchart for explaining a control method for the image forming apparatus;

FIG. 12 is a flowchart for explaining the control method for the image forming apparatus;

FIG. 13 is a flowchart for explaining the control method for the image forming apparatus;

FIG. 14 illustrates screen display for explaining a display method for the image forming apparatus;

FIG. 15 is a flowchart for explaining a control method for the image forming apparatus;

FIG. 16 is a timing chart for explaining a control method for the image forming apparatus when a problem occurs;

FIG. 17 is a timing chart for explaining the control method for the image forming apparatus; and

FIG. 18 is a flowchart for explaining the control method for the image forming apparatus.

### DESCRIPTION OF THE EMBODIMENTS

The best mode for carrying out the present invention will be described below with reference to the drawings.

### First Embodiment

### Explanation of Structure of System

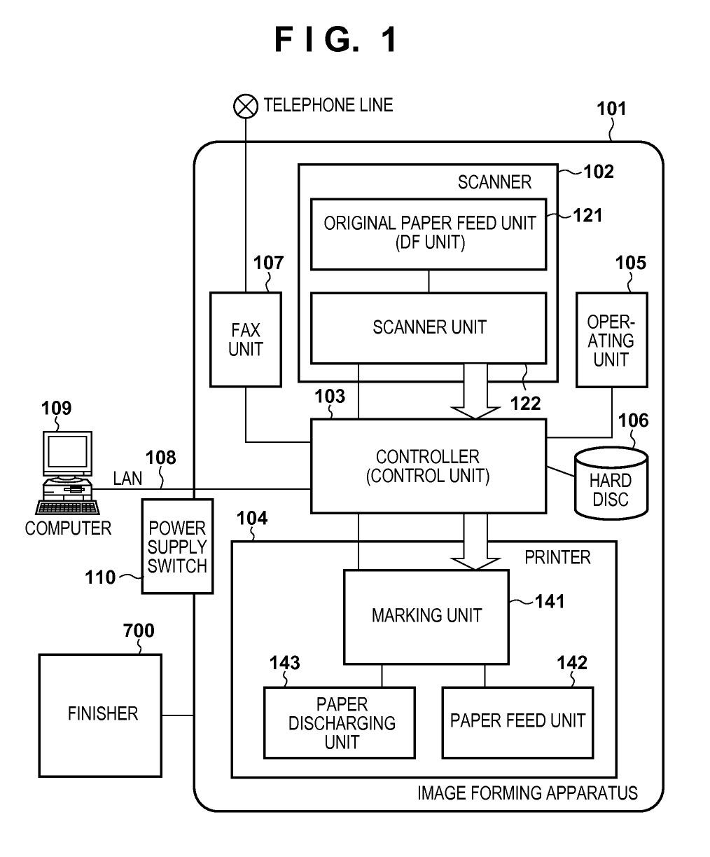

FIG. 1 is a block diagram for explaining a structure of an image forming system according to the present embodiment. In this example, a multifunction printer provided with a printing function, a scanner function, a data communication function, and the like, will be described as an example.

In FIG. 1, an image forming apparatus 101 is configured to be able to receive a job from a computer 109 via a LAN 108. It should be noted that one or more computers may be connected. A scanner 102 optically reads an image from an original and converts the image into a digital image. A printer 104 outputs the digital image to a paper device which is referred to as paper. An operating unit 105 includes a touch panel or a hard key for receiving setting to the apparatus from a user or displaying a processing state. A hard disc 106 stores a digital image, a control program, or the like. A FAX unit 107 transmits and receives a digital image to and from telephone lines, or the like. A controller 103, the scanner 102, the printer 104, the operating unit 105 and the hard disc 106 execute a job on the image forming apparatus 101 by being connected to the FAX unit 107 and issuing an instruction to each module.

The image forming apparatus 101 can also input and output a digital image, issue a job, instruct equipment, or the like, from the computer 109 via the LAN 108. The scanner 102 is comprised of an original paper feed unit 121 capable of sequentially and automatically replacing an original bundle and a scanner unit 122 capable of optically scanning an original and converting the scanned data into a digital image, and the converted image data is transmitted to the controller 103.

The printer 104 is comprised of a paper feed unit 142 capable of sequentially feeding one sheet each from a paper bundle, a marking unit 141 for printing image data on the fed paper, and a paper discharging unit 143 for discharging paper on which printing is performed. A finisher 700 performs processing such as paper discharging, sorting, stapling, punching and cutting on the paper device output from the paper discharging unit 143 of the printer 104 of the image forming apparatus 101.

Further, the image forming apparatus 101 has a power supply switch 110 connected to the controller 103.

### DEFINITION

Next, a sleep state and a standby state will be described. The sleep state is a power standby state where part of the image forming apparatus 101 is powered down. Part of a power saving function of the image forming apparatus 101 will be described below.

A function of setting time for automatically transitioning to a sleep state (auto-sleep time) is a function for making a state of the image forming apparatus 101 transition to the sleep state at time designated by a user setting a day of the week or time at which he desires to put the apparatus into the sleep state. A function of setting a period for automatically transitioning to the sleep state (auto-sleep timer) is a function for making the state of the image forming apparatus 101 transition to the sleep state when the image forming apparatus 101 is not operated for a given period of time by the user setting the period.

A function of setting time for automatically shutting down the apparatus (auto-shutdown time) is a function for making the state of the image forming apparatus 101 transition to an OFF state at time designated by the user setting a day of the week or time at which he desires to shut down the apparatus.

A function of setting a period for transition to auto shutdown (auto-shutdown timer) is a function for making the state of the image forming apparatus 101 transition to an OFF state when the image forming apparatus 101 is not operated for a given period of time by the user setting the period.

The standby state is a state where functions can be immediately used. Hereinafter, state transition from the sleep state to the standby state will be referred to as return from the sleep state.

The image forming apparatus 101 implements a function of making the state of the image forming apparatus transition to the standby state at the time designated by the user to improve convenience. Part of functions for improving convenience of the image forming apparatus 101 will be described below.

A function of setting time for returning from the sleep state (time for returning from the sleep state) is a function for making the apparatus return from the sleep state and raising the temperature of the printer so that printing is possible at the time designated by the user setting time at which he desires to make the apparatus return to the standby state.

The time at which the image forming apparatus returns from the sleep state is time obtained by subtracting a heat-up period of a fixer from the designated time. An example of various jobs (functions) which can be executed by the image forming apparatus 101 will be described below.

[Copy Function]

The image forming apparatus 101 has a copy function of recording an image read from the scanner 102 in the hard disc 106 while printing the image using the printer 104.

[Image Transmission Function]

The image forming apparatus 101 has an image transmission function of transmitting the image read from the scanner 102 to the computer 109 via the LAN 108.

[Image Storage Function]

The image forming apparatus 101 has an image storage function of recording the image read from the scanner 102 in the hard disc 106 and performing image transmission or image printing as necessary.

[Image Printing Function]

The image forming apparatus 101 has an image printing function of analyzing, for example, page description language transmitted from the computer 109 and printing the page description language using the printer 104.

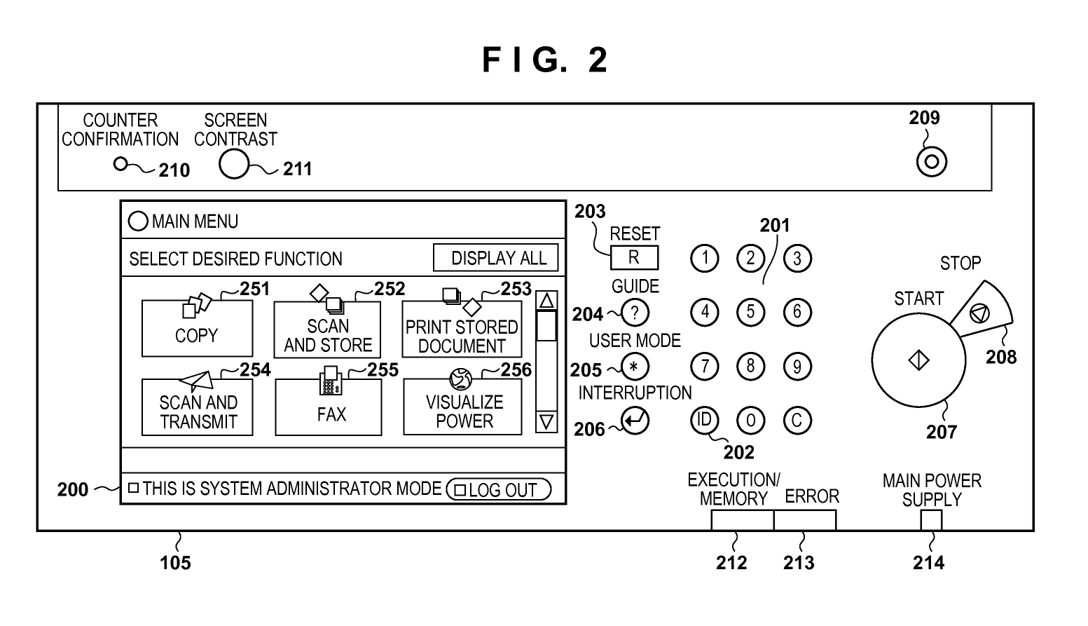

FIG. 2 is a plan view for explaining a structure of the operating unit 105 illustrated in FIG. 1. It should be noted that the operating unit 105 is connected to the controller 103, is constituted with an LCD touch panel, or the like, and provides a user I/F for allowing the user to operate an image input/output system.

In FIG. 2, mode setting and state display are mainly performed on the LCD touch panel 200. A numeric keypad 201 is comprised of keys for inputting numerical values from 0 to 9. An ID key 202 is used to input a department number and a security mode when the apparatus is managed for each department. A reset key 203 is a key for resetting the set mode, a guide key 204 is a key for displaying a screen for explaining each mode, a user mode key 205 is a key for entering a user mode screen, and an interruption key 206 is a key for performing interruption copy. A start key 207 is a key for starting copy operation, and a stop key 208 is a key for cancelling a copy job being executed. When a power saving key 209 is depressed, a backlight of the LCD touch panel 200 is turned off, and the apparatus is put into a sleep state (a second power state). When a counter confirmation key 210 is depressed, a counter screen indicating the total number of copied sheets used until then is displayed on the LCD touch panel 200. An adjustment key 211 is a key for adjusting contrast of the LCD touch panel 200.

An LED 212 is an LED indicating that a job is being executed, and an image is being accumulated in an image memory, an LED 213 is an error LED indicating that the apparatus is put into an error state such as a jam or a state where a door is open, and an LED 214 is a power supply LED indicating that a main power supply switch of the apparatus is turned on. When the main power supply switch is turned on, power is fed to at least a power supply control unit 503 described below, the operating unit 105 and part of a main board 300 of the controller 103.

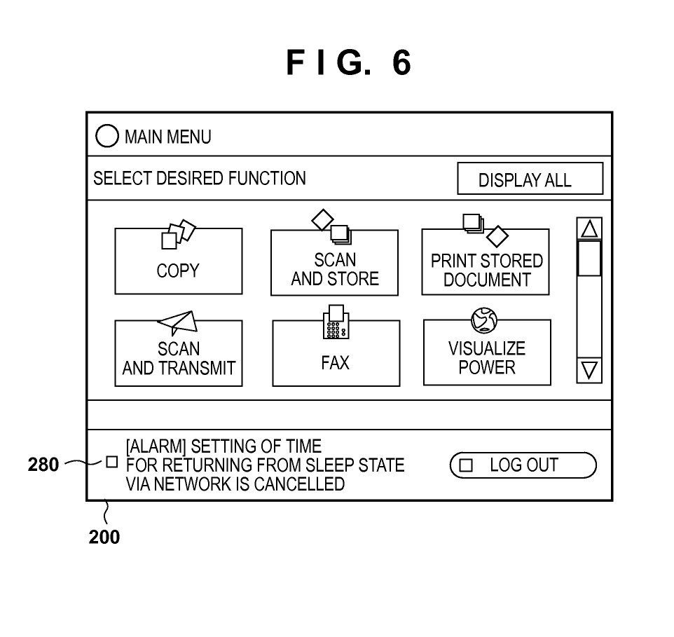

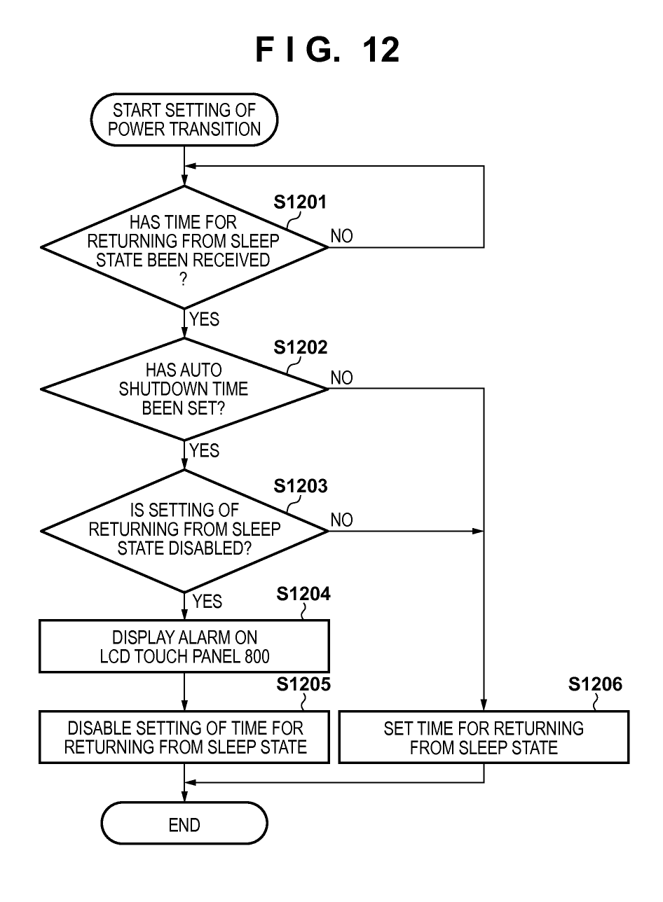

Keys 251, 252, 253, 254, 255 and 256 which function as keys corresponding to respective functions, are keys for functions of copy, scanning and storage, printing of stored documents, scanning and transmission, FAX and power visualization or keys for transitioning to screens for the functions. The copy key 251 is a key for transition to a screen for a copy function. The scan and store key 252 is a key for transitioning to a screen for storing an image scanned by the scanner 102 in an HDD 106. The print stored document key 253 is a key for transitioning to a function for printing the image stored in the HDD 106 using the printer 104. The scan and transmit key 254 is a key for transitioning to a function of transmitting the image scanned by the scanner 102 to the computer 109 via the LAN 108. The FAX key 255 is a key for transitioning to a function of printing data received by the FAX unit 107 from telephone lines using the printer 104 via the controller 103. The visualize power key 256 is a key for transitioning to a function of confirming a power state of the image forming apparatus 101 on the LCD touch panel 200. FIG. 6 is an enlarged view of the LCD touch panel 200. While FIG. 6 includes a message 280 according to the present embodiment that sleep setting has been disabled, this will be described along with FIG. 12, or the like.

<Structure of Controller 103>

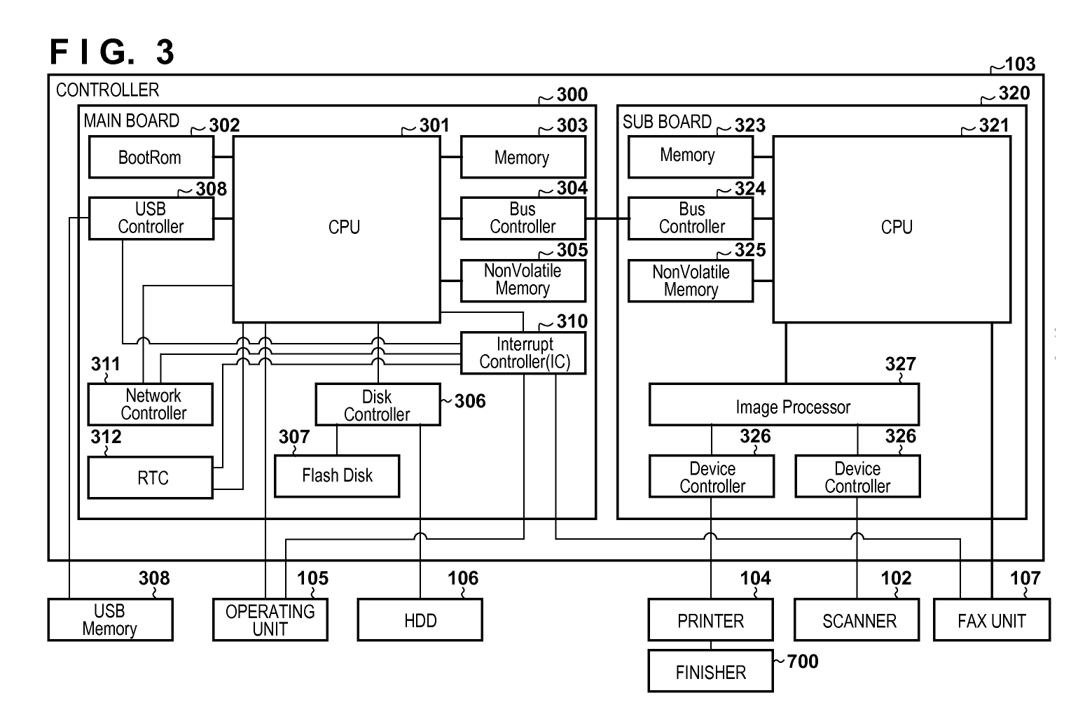

Subsequently, a block diagram of the controller will be described using FIG. 3. The controller 103 which is a module to which the present invention is specifically applied will be described using FIG. 3. FIG. 3 is a block diagram for explaining a structure of the controller 103 illustrated in FIG. 1. A power supply state of this example is a standby state, which indicates that power is supplied to all the devices.

In FIG. 3, the controller 103 is constituted with the main board 300 and a sub board 320. The main board 300 is a so-called general purpose CPU system. The main board 300 includes a CPU 301 which controls the whole board, a boot ROM 302 including a boot program, a memory 303 used by the CPU as a work memory, a bus controller 304 having a bridge function with an external bus, and a non-volatile memory 305 whose content is not erased even if the apparatus is powered down. The main board 300 further includes a disc controller 306 which controls a storage apparatus, a flash disc 307 such as an SSD, which is a storage apparatus constituted with a semiconductor device and having relatively small capacity, a USB controller 308 capable of controlling a USB, or the like.

A USB memory 309, the operating unit 105, the hard disc 106, or the like, are connected to the outside of the main board 300. Further, the CPU 301 is connected to the interruption controller 310, and further connected to a network controller 311, a real time clock (RTC) 312, the FAX unit 107, the operating unit 105 having the power saving key 209, the USB controller 308 and the power supply switch 110.

The sub board 320 is constituted with a relatively small general-purpose CPU system and image processing hardware. The sub board 320 has a CPU 321 which controls the whole board, a memory 323 used by the CPU as a work memory, a bus controller 324 having a bridge function with an external bus, a non-volatile memory 325 whose content is not erased even if the apparatus is powered down, an image processor 327 which performs real time digital image processing, and a device controller 326.

The external scanner 102 and the external printer 104 receive and transmit digital image data via the device controller 326. The FAX unit 107 is directly controlled by the CPU 321. The paper device discharged from the printer 104 is processed at the finisher 700.

It should be noted that FIG. 3 is a simplified block diagram. For example, while the CPU 301, the CPU 321, or the like, include a number of CPU peripheral hardware elements such as a chip set, a bus bridge and a clock generator, these are abbreviated to simplify the illustration, and, thus, this block diagram does not limit the present invention.

Operation of the controller 103 will be described using an example of image copy using a paper device. When the user gives an instruction of image copy from the operating unit 105, the CPU 301 transmits an image reading instruction to the scanner 102 via the CPU 321. The scanner 102 optically scans a paper original and converts the scanned data into digital image data and inputs the digital image data to the image processor 327 via the device controller 326. The image processor performs DMA transfer to the memory 323 via the CPU 321 to temporarily store the digital image data.

When the CPU 301 confirms that a certain amount or all the digital image data is stored in the memory 323, an image output instruction is issued to the printer 104 via the CPU 321. The CPU 321 notifies the image processor 327 of a location of the image data in the memory 323. The image data on the memory 323 is transmitted to the printer 104 via the image processor 327 and the device controller 326 according to a synchronization signal from the printer 104. The printer 104 prints the digital image data on the paper device. When a plurality of copies are made, the CPU 301 stores the image data of the memory 323 in the hard disc 106 so that it is possible to transmit the image to the printer 104 without receiving the image from the scanner 102 for making the second copy or thereafter.

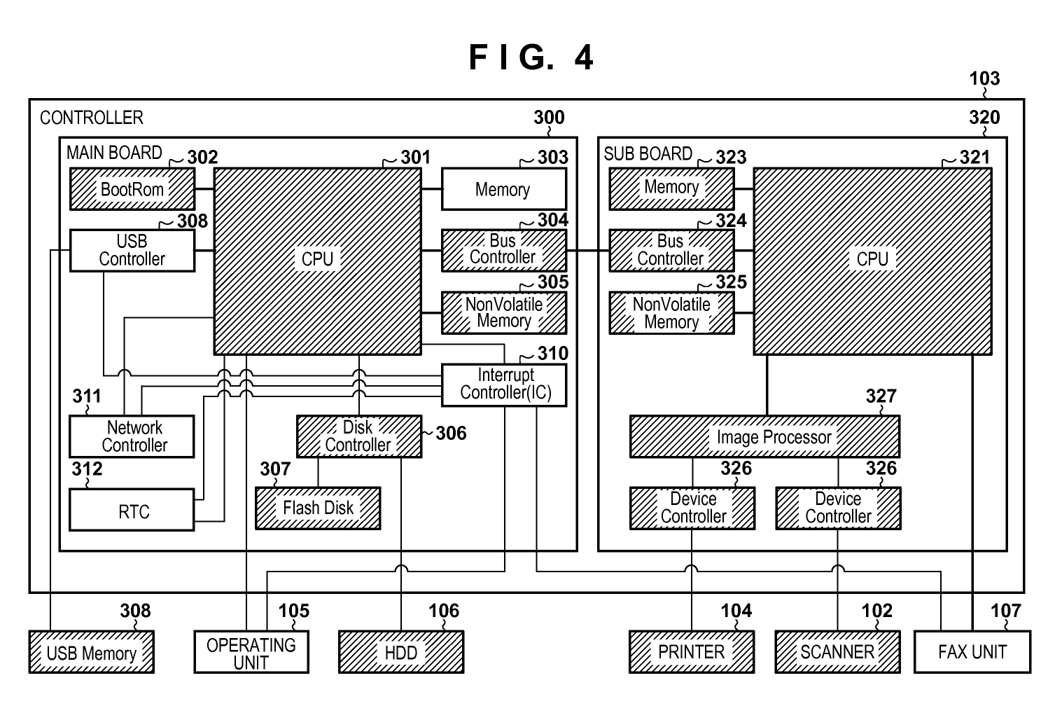

FIG. 4 is a block diagram for explaining a structure of the controller 103 illustrated in FIG. 1. A power supply state of FIG. 4 corresponds to a state where the controller 103 is put into a sleep state. Power is not supplied to a shaded area in the figure. It should be noted that, in the present embodiment, the sleep state is a state where the apparatus can be activated in a shorter period of time than in a case of normal activation while power consumption is suppressed. In the sleep state, power is supplied to specific circuits, and power supply to the other part is stopped. When a user does not perform operation for a given period of time or when a power saving switch 214 on the operating unit 105 is depressed while the apparatus is powered on, the state transitions to the sleep state. The controller 103 which is a module to which the present invention is specifically applied will be described using FIG. 4.

In the sleep state, power is fed to minimum required parts such as the memory 303 and the interruption controller 310 on the controller 103. Further, in the sleep state, power is fed to the network controller 211 which transmits interruption for returning from the sleep state to the interruption controller 310, the RTC 212, the USB controller 308, the power saving key 209 on the operating unit 105, various sensors, part of the FAX unit 107 and the power supply switch 110. That is, power is fed to circuits other than the shaded area in the figure during the sleep state.

The interruption controller 310 receives interruption from one or more of incoming on the network, the RTC which detects a timer or an alarm, the FAX which detects incoming and off hook, the power saving key 209, sensor detection, the USB which detects insertion and extraction, and communication, and the power supply switch 110 during the sleep state. Upon reception of interruption, the interruption controller 310 notifies the CPU 301 of a cause of the interruption. The CPU 301 performs processing of returning power feeding and the state of software to a normal state in response to the notification. However, because triggers of returning from the sleep state differ depending on systems, power feeding during the sleep state is not limited to this structure.

<Power Supply>

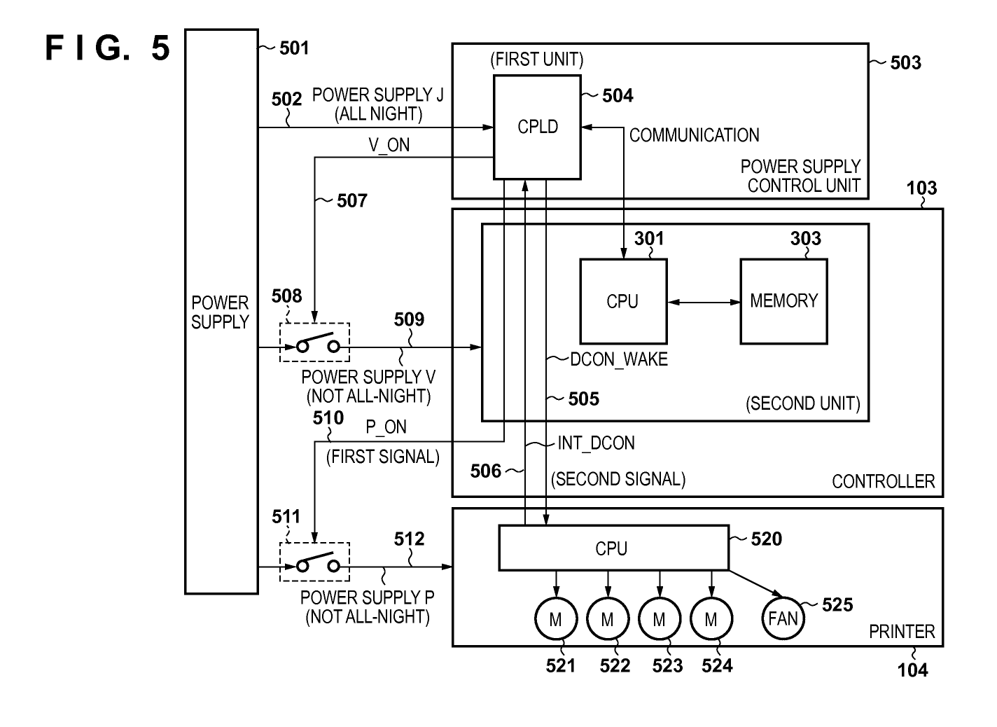

FIG. 5 is a block diagram for explaining a structure of power supplies of the image forming apparatus 101 illustrated in FIG. 1. Part of the structure of the controller 103, the printer 104, the power supply control unit 503 and the power supply 501 in the image forming apparatus 101 relating to the present invention will be described below using FIG. 5. In FIG. 5, power is always supplied to the power supply control unit 503 via a power supply line J502 which is a first power supply line. However, because power consumption is minute, power is only supplied to this power supply control unit 503 and controlled during the power saving mode.

A CPLD (Complex Programmable Logic Device) 504 is programmed in advance so as to execute desired operation described below. That is, power supply to the controller 103 is controlled by an IO signal V_ON 507 which is a first power supply control signal, so that the power is supplied via a power supply line V509 which is a second power supply line from the power supply 501 by a relay switch 508 being switched. Further, a plurality of timer values are set through communication from the CPU 301, and the operation set by the CPU 301 is executed when the apparatus is activated by the timer.

Further, power supply to the printer 104 is controlled by an IO signal P_ON 510 which is a second power supply control signal, so that the power is supplied via a power supply line P512 which is a third power supply line from the power supply 501 by a relay switch 511 being switched. Further, predetermined IO signals are made to operate by an instruction from the CPU 301. One of the IO signals made to operate is a DCON_LIVEWAKE signal 505 which is connected to the CPU of the printer. When the printer 104 is powered on while this signal is asserted, the printer 104 calmly returns to a normal state without performing specific operation which controls operable units or consumes power. The specific operation includes, for example, rotation operation of a motor, a roller, a polygon, or the like, temperature control of drums 521 to 524, exhaust heat processing by a FAN 525. The scanner 102 can also be controlled from the CPLD 504 as with the printer 104, which will be abbreviated here. That is, the same power supply control as that performed for the printer 104 is also performed for the scanner 102.

It should be noted that power can be fed for each block as illustrated in FIG. 4 by constituting the relay switch 508 with two systems, and turning off only the relay switch which leads to a block to be powered off and keeping the other switch on during the sleep state. In a shutdown state, the relay switches of the both systems are turned off. In that case, the power supply control signal is not a binary control signal, but is a multi-value control signal according to power supply states. While this description will be omitted in this example, power is supplied under control as described above during the sleep state and the shutdown state.

<Power Supply Monitoring>

A signal for switching to a sleep mode is also input to the power supply control unit 503 from the power saving key 209 on the operation panel 105. The power supply control unit 503 can power on the controller 103, the printer 104, the scanner 102, or the like, via the power supply control signals 507 and 510 in a state where power is not supplied to the CPU 301. Further the power supply control unit 503 can power off these components. Further, for example, when the power saving key 209 is operated, the CPU 301 can receive a state of the power saving key 209 via the power supply control unit 503. The CPU 301 detects an instruction of transitioning to the sleep state and activates a sleep sequence to instruct the power supply control unit 503 to transition to the sleep state. As a result, the power supply control unit 503 turns off the relay switches 508 and 511 via the power supply control signals 507 and 510 and turns off the controller 103, the printer 104 and the power supply line V509 and the power supply line P512 which are DC power supply sources of these, so that the system is put into a sleep state. When the CPU 301 detects an instruction of returning from the sleep state, the CPU 301 activates a sequence for returning from the sleep state to instruct the power supply control unit 503 to return from the sleep state. Transition to the sleep state or return from the sleep state is triggered at set designated time as well as depression of the power saving key 209, and also triggered by an instruction from the computer 109 which is an external apparatus. This also applies to a case where the apparatus is shut down or started, as well as a case where the state transitions to the sleep state or returns from the sleep state. The apparatus can be also shut down using the power supply switch 110 in addition to the above-mentioned triggers. Further, shutting down is different from the sleep state in that when the apparatus is shut down, power is not fed to the circuits on the main board 300, while power is fed to the circuits on the main board 300 during the sleep state. Because when the apparatus is shut down, a program on the CPU 301 is completely finished, the program on the CPU 301 is activated as usual when a power supply control signal for turning on the apparatus is received next time.

[Power Feeding Processing in Active State]

Activation processing of the image forming apparatus 101 will be described next. An operator turns on the power supply switch 110 when using the image forming apparatus 101. The power supply control unit 503 then detects power-on by the power supply line 502 and turns on the relay switches 508 and 511 using the power supply control signals 507 and 510, so that the power supply 501 supplies power to the whole apparatus. The power supply control unit 503 supplies power to the whole system according to the power-on, specifically, feeds power to the controller 103, the printer 104 and the scanner 102 via each DC power supply path. The CPUs of the printer 104 and the scanner 102 each start initialization operation by the power-on.

[Power Feeding State in Sleep State]

The sleep state of the image forming apparatus 101 will be described next. The sleep state is a state where the apparatus can be activated in a shorter period of time than in a case where the apparatus is normally activated while power consumption is suppressed. When the user does not perform operation for a given period of time or depresses the power saving key 209 on the operating unit 105, or at the set time, the state transitions to the sleep state. Also during the sleep state, power is fed to the memory 303, the interruption controller 310, the network controller 311, the RTC 312, the USB controller 308, or the like, of the controller 103, the power saving key 209 on the operating unit 105, part of the FAX unit 107 and various sensors. However, because triggers of returning from the sleep state are different depending on systems, power feeding during the sleep state is not limited to this structure.

Operation of the software when the state returns from the sleep state will be described. The interruption controller 310 receives interruption of one or more of incoming on the network, the RTC which detects a timer and an alarm, a FAX which detects incoming or off hook, a soft switch, various sensors, and an USB which detects insertion and extraction and communication during the sleep state. The interruption controller 310 notifies the CPU 301 of a cause of the interruption, and the CPU 301 performs processing of returning power feeding or the state of the software to a normal state, that is processing of returning from the sleep state in response to the notification.

[Power Feeding State when Printer 104 and Scanner 102 are not Used in Normal State]

Subsequently, power feeding in a normal state of the image forming apparatus 101 when the printer 104 and the scanner 102 are not used will be described. The normal state is not limited to a state where power is fed to all the units. The normal state includes a state where power is not supplied to the printer 104 when printing is not performed, and a state where power is not supplied to the scanner 102 when the operating unit 105 does not light up, and it is recognized that the user is not in front of the image forming apparatus 101.

While the apparatus is powered on in order to accelerate finishing of printing at the printer 104 or finishing of reading at the scanner 102, there is an operation standby state which is a state where a motor or a polygon for printing is not activated, a state where temperature control is not performed on a transfer unit for printing, or a state where home position detection for reading is not activated.

[Power Feeding State of Printer 104 and Scanner 102 Upon PDL Printing]

Subsequently, power feeding of the image forming apparatus 101 in a state where the printer 104 and the scanner 102 are used in a PDL printing state will be described. Power-on and power-off of the printer 104 will be described using an image printing function.

The CPU 301 of the controller 103 receives data in the memory 303 from the computer 109 via the LAN 108. The CPU 301 analyzes the received data and generates a print job when executing the image printing function.

The CPU 301 notifies the CPLD 504 to switch the relay switch 511 using the power supply control signal 510 so that power is fed to the printer 104 via the power supply line P512 from the power supply 501. The CPU 301 executes the print job when the printer 104 is put into a usable state. The CPU 301 transmits data to the printer 104 from the memory 303 via the bus controller 304, the bus controller 324 of the sub board 320, the CPU 321 of the sub board 320, the image processor 327 and the device controller 326. The printer 104 prints the received data, and, when printing is completed, notifies the CPU 301 of the result. When printing is completed, the CPU 301 makes the power supply control unit 503 turn off the relay switch 511 using the power supply control signal 510 via the power supply control unit 503 and power off the printer 104.

[Activation Processing of Controller 103]

Subsequently, activation processing of the controller 103 will be described. The power supply control unit 503 detects that power-on from the power supply line J502, and turns on the relay switch 508 using the power supply control signal 507, so that power is fed to the controller 103. The CPU 301 initializes hardware. The initialization of the hardware includes initialization of a register, initialization of interruption, registration of a device driver upon kernel activation, and initialization of the operating unit 105.

The CPU 301 then initializes software. The initialization of the software includes invoking of an initialization routine of each library, activation of process or thread, activation of software service for performing communication with the printer 104 and the scanner 102, and drawing at the operating unit 105. Finally, the state transitions to the standby state.

[Processing of Transition to Sleep State of Controller 103]

Subsequently, processing of transition to the sleep state of the controller 103 will be described. When the apparatus is in the standby state where the user does not use the apparatus for a given period of time, the CPU 301 is put into the sleep state. The CPU 301 notifies the power supply control unit 503 that the CPU 301 is put into the sleep state and changes power feeding to the controller 103 to power feeding as described above using the block diagram of FIG. 4 which illustrates the controller 103 during the sleep state. It should be noted that as described above, the power feeding for each block as illustrated in FIG. 4 can be achieved by, for example, constituting the relay switch 508 with two systems and turning off only the relay switch which leads to a block to be powered off and keeping the other relay switch on during the sleep state.

[Processing of Returning from Sleep State of Controller 103]

Subsequently, processing of returning from the sleep state of the controller 103 will be described. When the power supply control unit 503 receives a trigger of returning from the sleep state after receiving a depression event of the power saving key 209 which is a trigger of returning from the sleep state, during the sleep state, the CPU 301 returns from the sleep state. The CPU 301 notifies the power supply control unit 503 that the CPU 401 returns from the sleep state, and the power supply control unit 503 turns on the relay switches 508 and 511 using the power supply control signals 507 and 510, so that power is fed to the controller 103, the printer 104 and the scanner 102. It should be noted that while a power supply control signal for the scanner 102 is not illustrated in FIG. 5, the power supply control signal can be used in common with the printer, or can be prepared as a signal which is not illustrated.

When the print job is finished, the CPU 301 is put into the sleep state again. The CPU 301 notifies the power supply control unit 503 that the CPU 301 is put into the sleep state, and the power supply control unit 503 turns off the relay switch 511 using the power supply control signal 510, so that power feeding to the components other than the controller 103 is stopped.

Further, in a similar manner, a case where an event of incoming on the network, which is a trigger of returning from the sleep state occurs during the sleep state will be studied. The power supply control unit 503 receives the trigger of returning from the sleep state and turns on the relay switch 508 using the power supply control signal 507, so that power is fed to the controller 103. By this means, the CPU 301 returns from the sleep state. It is not necessary to feed power to the printer 104 and the scanner 102 when a job is not generated or when device information is not required to be acquired.

### Description of Sequence of First Embodiment

In the present embodiment, additional setting is disabled when state transition time is tried to be newly set immediately before the originally set state transition time.

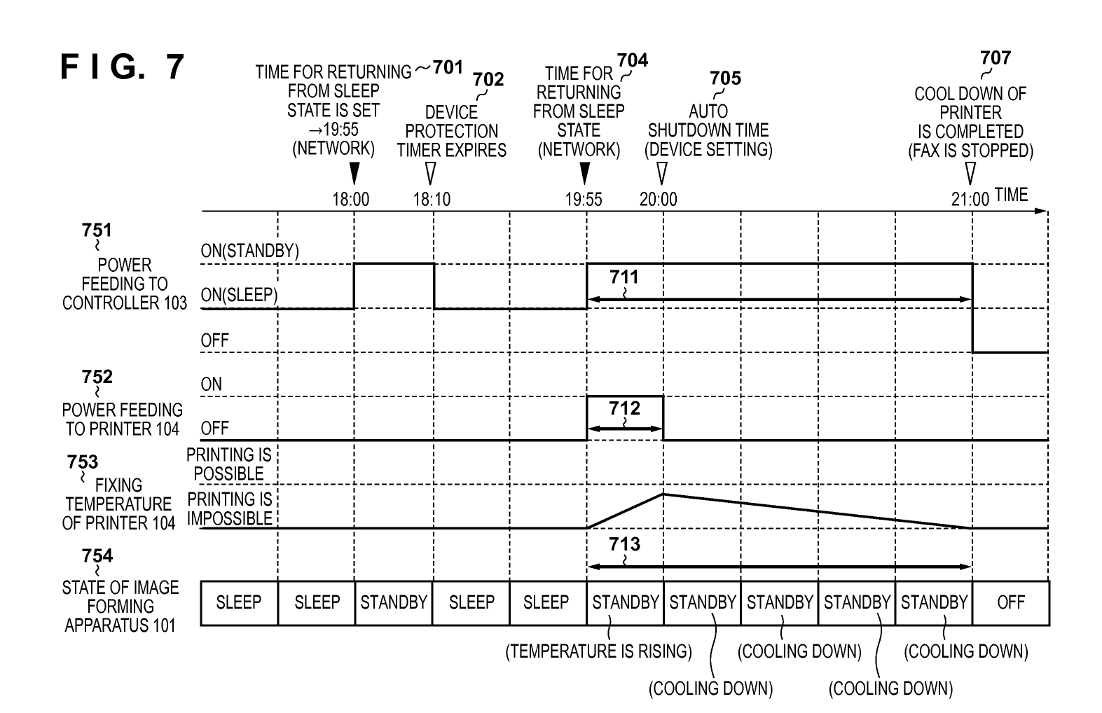

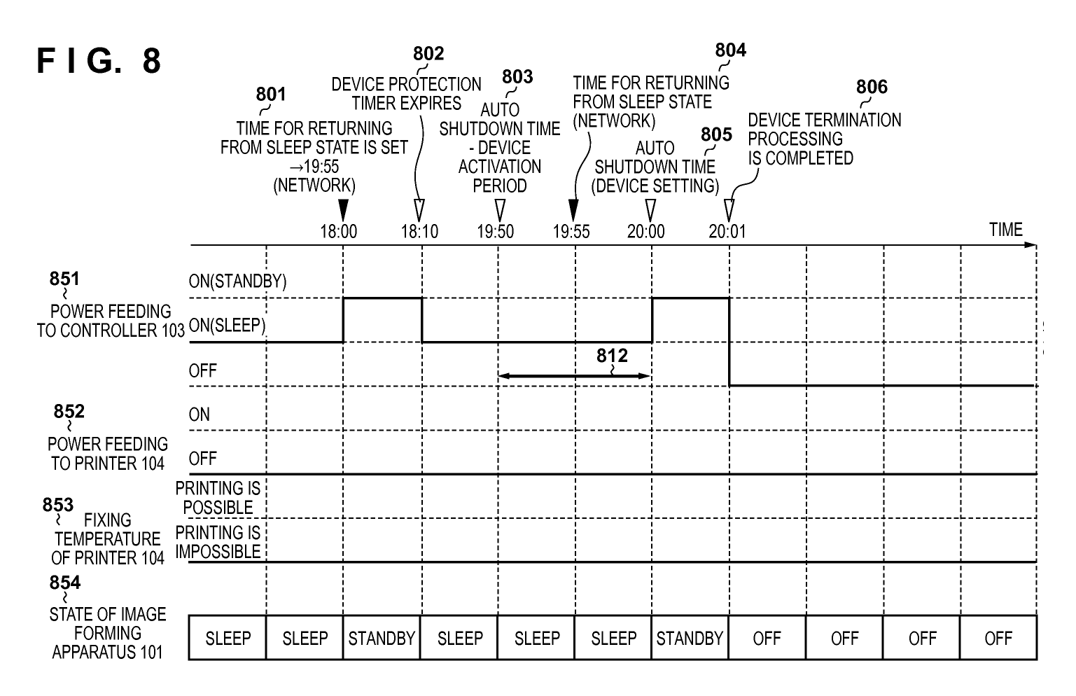

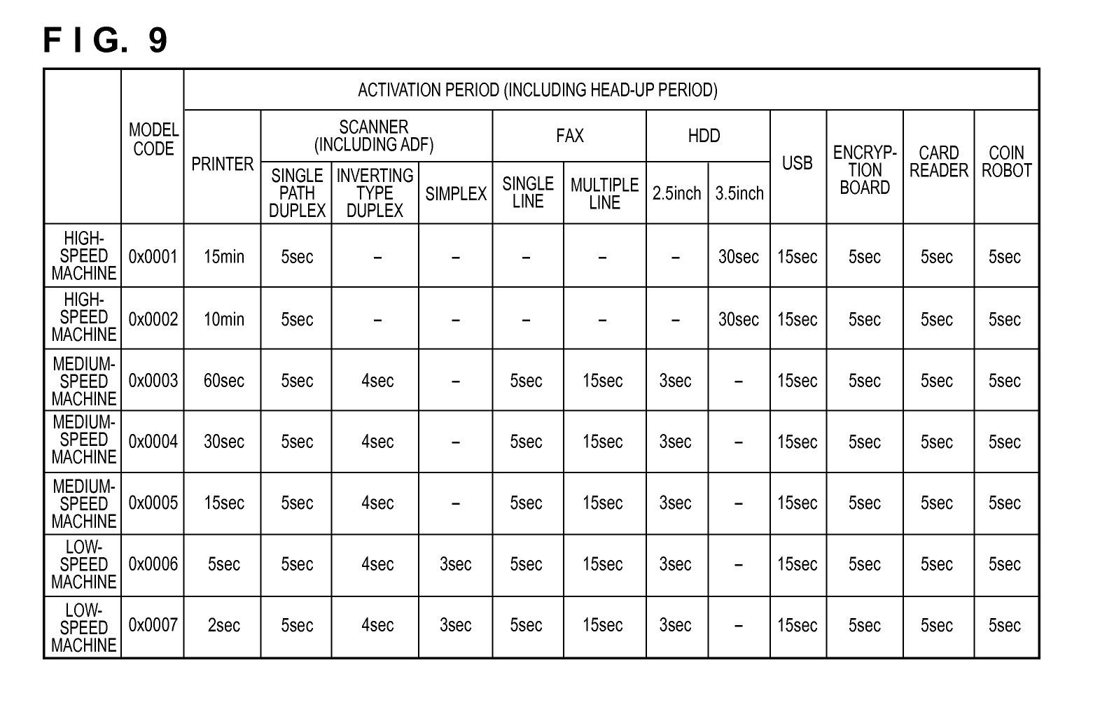

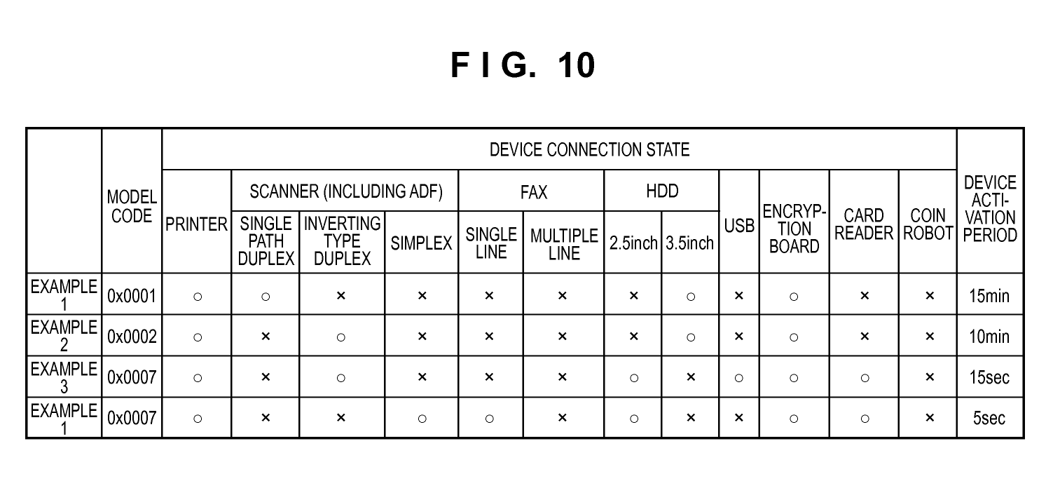

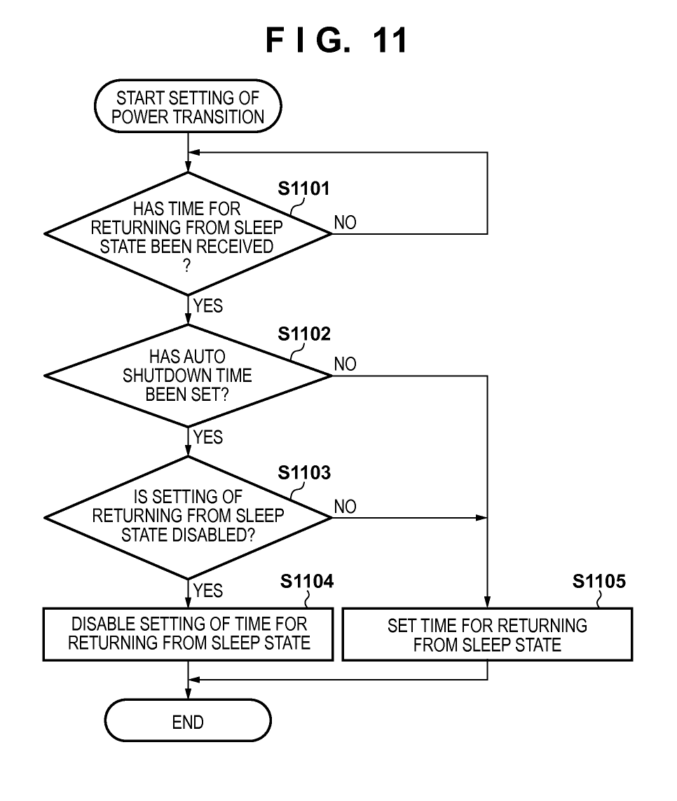

A timing chart, a method for calculating a device activation period and a flowchart of the first embodiment will be described below using FIG. 7, FIG. 8, FIG. 9, FIG. 10 and FIG. 11. The device activation period is a period required from when a device is activated until when the device is put into a standby state, and, for example, a period determined according to a period required for a fixing unit to reach a predetermined fixing temperature.

FIG. 7 is a timing chart for explaining a conventional control method. An example where power is wasted when state transition time is newly set immediately before the originally set state transition time will be described below.

The ordinate indicates a power feeding state 751 of the controller 103, a power feeding state 752 of the printer 104, a fixing temperature 753 of the printer 104 and a state 754 of the image forming apparatus 101.

The power feeding 751 of the controller 103 is indicated with three states of ON during a standby state (also referred to as a standby state), ON during a sleep state (also referred to as a sleep state) and OFF.

The power feeding 752 of the printer 104 is indicated with two states of ON and OFF.

The fixing temperature 753 of the printer 104 is indicated with two states of a state where printing is possible at which the temperature is equal to or higher than a predetermined value, and a state where printing is impossible at which the temperature is lower than the predetermined value, and forms an analog waveform in which the temperature rises by the power feeding 752 being turned on, while the temperature decreases by the power feeding 752 being turned off.

The abscissa indicates time. A black triangle indicates an event designated by the user, while a white triangle indicates an event designated by the image forming apparatus.

Auto shutdown time 705 is time set to the image forming apparatus 101 in advance by the user. The setting is stored, and it is monitored whether or not the time reaches the set time by a real time clock (RTC). The time for returning from the sleep state is time set via the network in the present embodiment. The auto shutdown time and the time for returning from the sleep state can be set so as to exist together in the image forming apparatus 101. An example of a problem in setting of the image forming apparatus will be described according to the temporal axis using the above.

At 18:00, the image forming apparatus 101 receives setting via the LAN 108 so that the time for returning from the sleep state be set at 19:55 (701). By this means, the image forming apparatus 101 makes the power feeding 751 of the controller 103 transit from the sleep state to the standby state and sets 19:55 as the sleep time 704 in alarm service. Subsequently, a device protection timer having an upper limit of the number of times of power-on operates, and, when the timer expires at 18:10 after a given period of time, the image forming apparatus 101 makes the power feeding 751 of the controller 103 transit from the standby state to the sleep state (702).

At 19:55, the image forming apparatus 101 makes the power feeding 751 of the controller 103 transit from the sleep state to the standby state by the setting of the alarm service set as described above (704). At the same time, the image forming apparatus 101 makes the power feeding 752 of the printer 104 transit from OFF to ON, and the fixing temperature 753 of the printer 104 starts rising. In the present embodiment, a heat-up period of the printer 104 is set at 10 minutes.

When it is 20:00 which is the auto shutdown time 705 set in advance by the user in the image forming apparatus 101, termination processing is started. In this example, a cooling period (cooling-down period) of the printer 104 is set at 1 hour. Therefore, cooling down is completed at 21:00 which is cool-down completion time 707, and the apparatus is shut down.

As a result, the image forming apparatus 101 wastes power although the apparatus cannot eventually perform printing. A period during which the apparatus wastes power includes a period required to raise the temperature of the printer 104 after the apparatus returns from the sleep state and a cooling period 713 after the apparatus is automatically shut down and power feeding to the printer 104 is stopped. Specifically, the period during which the apparatus wastes power includes a period 712 during which the temperature of the printer 104 is raised and a period 711 during which the printer 104 is cooled down using the FAN of the controller 103. During these periods, the power is wasted although the printer 104 cannot be used.

FIG. 8 is a timing chart for explaining a control method for the image forming apparatus according to the present embodiment. An example of preventing waste of power when state transition time is newly set immediately before the originally set state transition time will be described below. The ordinate and the abscissa are the same as those in FIG. 7.

At 18:00, the image forming apparatus 101 receives setting via the LAN 108 that the time for returning from the sleep state be set at 19:55 (801). By this means, the image forming apparatus 101 makes power feeding 851 of the controller 103 transit from the sleep state to the standby state. At this time, the image forming apparatus 101 confirms auto shutdown time 805 and calculates a device activation period. The device activation period may be a fixed value. It is assumed that the device activation period is, for example, 10 minutes. It is determined whether or not the received time for returning from the sleep state 804 (19:55 in this example) is between the set auto shutdown time 805 (20:00 in this example) and time 803 obtained by subtracting the device activation period (10 minutes in this example) from the auto shutdown time (812). In the example of FIG. 8, it is determined whether or not 19:55 which is the time for returning from the sleep state is before 19:50 which is before the auto shutdown time 20:00 by the device activation period (10 minutes). Even if the apparatus returns from the sleep state during this period, the printer 104 will be shut down without being put into a usable state. Therefore, if the time for returning from the sleep state 804 is time reaching the auto shutdown time 805 before the device activation period has elapsed even if the apparatus returns from the sleep state, the time for returning from the sleep state is not set even if the setting of the time for returning from the sleep state is received. The subsequent process is the same as that in FIG. 7, and the controller 103 is put into a sleep state at time 802 at which the device protection timer expires, and shutdown starts at the auto shutdown time 805 and is completed at time 806.

According to the above structure, because the image forming apparatus 101 does not perform power feeding 752 of the printer 104, it does not take time to cool down the printer, and, thus, device termination processing can be completed in a short period of time, so that it is possible to reduce power consumption.

<Device Activation Period>

FIG. 9 is an activation period table A for explaining an activation period including a heat-up period, of each device constituting the image forming apparatus according to the present embodiment. FIG. 10 is a device structure table B for explaining a connection state of the devices constituting the image forming apparatus according to the present embodiment. A method for calculating the device activation period will be described using the table A and the table B.

A maximum period in the table A among devices indicated by circles in the table B becomes a device activation period in table B. In an example 1 in the table B, there are a printer, a single path duplex scanner, a 3.5 inch HDD and an encryption board as the devices indicated by circles for a model code of 0x0001. Therefore, as a result of comparing 15 minutes of the printer, 5 seconds of the single path duplex scanner, 30 seconds of the 3.5 inch HDD and 5 seconds of the encryption board, which are the activation periods of the respective devices of the model code of 0x0001 in the table B, a maximum value of 15 minutes becomes the device activation period of the image forming apparatus of the model code of 0x0001. In an example 2 in the table B (a model code of 0x0002), as a result of comparing 10 minutes of the printer, 4 seconds of an inverting type duplex scanner, 30 seconds of the 3.5 inch HDD, and 5 seconds of the encryption board, a maximum value of 10 minutes becomes the device activation period. In an example 3 in the table B (a model code of 0x0007), as a result of comparing 2 seconds of the printer, 4 seconds of the inverting type duplex scanner, 3 seconds of a 2.5 inch HDD, 15 seconds of a USB, 5 seconds of the encryption board, and 5 seconds of a card reader, a maximum value of 15 seconds becomes the device activation period. In an example 4 of the table B (a model code of 0x0007), as a result of comparing 2 seconds of the printer, 3 seconds of a simplex scanner, 5 seconds of a single line FAX, 3 seconds of the 2.5 inch HDD, 5 seconds of the encryption board, and 5 seconds of the card reader, a maximum value of 15 seconds becomes the device activation period. Further, the device activation period may be a predetermined period of a fixed value. Because the structure of the image forming apparatus is determined for each image forming apparatus, for example, a structure table illustrated in FIG. 10 is held for each image forming apparatus. It is not necessary to provide a structure table for a plurality of models as illustrated in FIG. 10, but a table indicating the structure of the image forming apparatus may be used. It is also only necessary to provide an activation period table illustrated in FIG. 9 for the corresponding model. While the structure table is updated according to change of the structure, an activation period table which has been prepared in advance can be used as the activation period table. When the structure of the image forming apparatus is changed, the longest activation period among activation periods of the devices constituting the image forming apparatus is written as the device activation period of the image forming apparatus in the structure table as illustrated in FIG. 10 as described above. The activation period can be of course written in another region. When the device activation period is required, the device activation period at that time is referred to. It is of course possible to determine the device activation period from the structure table and the activation period table in each case. Alternatively, it is also possible to determine the device activation period in a fixed manner as described above.

<Procedure of Setting Time for Returning from Sleep State>

FIG. 11 is a flowchart for explaining a control method for the image forming apparatus according to the present embodiment. A flowchart for the case where waste of power is prevented when the state transition time is set immediately before the originally set state transition time will be described below.

The image forming apparatus 101 judges whether or not setting of the time for returning from the sleep state has been received (S1101). It should be noted that the procedure of FIG. 11 may be triggered by reception of the setting of the time for returning from the sleep state. When the setting of the time for returning from the sleep state has been received, it is judged whether or not an auto shutdown time has been already set and held (S1102). Because if the auto shutdown time has been set, the value of the auto shutdown time is stored in a predetermined storage location, it is possible to perform judgement with reference to the value. If the auto shutdown time has not been set, the time for returning from the sleep state is set (S1105). When the auto shutdown time is set, it is judged whether or not to disable the setting of the time for returning from the sleep state (S1103). Specifically, it is judged whether or not the received time for returning from the sleep state is included a period from time obtained by subtracting the device activation period from the auto shutdown time (that is, time earlier than the auto shutdown time by the device activation period) until the auto shutdown time, that is, the period before termination. If the received time is not included in the period before termination, the time for returning from the sleep state is set (S1105). If the received time is included in the period before termination, the received setting of the time for returning from the sleep state is disabled (S1104). That is, the received time for returning from the sleep state is ignored and is not set. It should be noted that the period before termination is a period during which even if the state returns from the sleep state during the period, auto shutdown starts before the image forming apparatus 101 is put into a usable state. The auto shutdown time can be replaced with a power saving function such as an auto sleep timer, auto sleep time and an auto shutdown timer. Further, step S1103 can be regarded as judgment as to whether or not the auto shutdown time is set within the device activation period, that is, a predetermined period from the received time for returning from the sleep state.

Further, a case where while the auto sleep time, the auto sleep timer, the auto shutdown time and the auto shutdown timer are set, schedule policy regarding power transition is set from outside of the image forming apparatus and power is wasted will be studied. In this case, power transition may be limited so that the state is not made to transition to the standby state, which will consume power, but is made to transition to the sleep state, which will not consume power.

As described above, when there is set schedule for performing auto shutdown before the state of the image forming apparatus transitions to the standby state even if the state returns from the sleep state at the set time for returning from the sleep state, by ignoring the setting of the time for returning from the sleep state, it is possible to prevent waste of power.

### Second Embodiment

In the present embodiment, when state transition time is tried to be newly set immediately before the originally set state transition time, the additional setting is disabled, and an alarm is displayed. The second embodiment will be described below using FIG. 12.

FIG. 12 is a flowchart for explaining a control method for the image forming apparatus according to the present embodiment. The flowchart for a case where if state transition time is newly set immediately before the originally set state transition time, an alarm is displayed when the setting is disabled to prevent waste of power will be described below. Because FIG. 12 is substantially the same as the flowchart of FIG. 11, a difference will be described.

Step S1201 and step S1202 are the same as step S1101 and step S1102 in FIG. 11. If the auto shutdown time has been set, it is judged whether or not to disable the received time for returning from the sleep state, that is, whether or not the received time for returning from the sleep state is included in the period before termination (S1203). If the received time for returning from the sleep state is disabled, that is, the received time for returning from the sleep state is included in the period before termination, an alarm is displayed on the LCD touch panel 200 (S1204), and the setting of the time for returning from the sleep state is disabled (S1205). On the other hand, if it is judged in S1203 not to disable the received time for returning from the sleep state, that is, there is a device activation period or longer between the time for returning from the sleep state and the auto shutdown time, the received time for returning from the sleep state is set (S1206). Further, an alarm may be displayed when the received setting of the time for returning from the sleep state is enabled as well as when the received setting of the time for returning from the sleep state is disabled.

FIG. 6 illustrates screen display for explaining a display method for the image forming apparatus according to the present embodiment. FIG. 6 illustrates one example of the alarm displayed on the LCD touch panel 200 in S1204 in the flowchart of FIG. 12. An alarm indicating, for example, that “Alarm, the setting of the time for returning from the sleep state via the network is cancelled” is displayed in a notification field 280 of the LCD touch panel 200.

By this means, it is possible to present to the user that the setting of the time for returning from the sleep state is disabled in addition to suppress waste power consumption.

### Third Embodiment

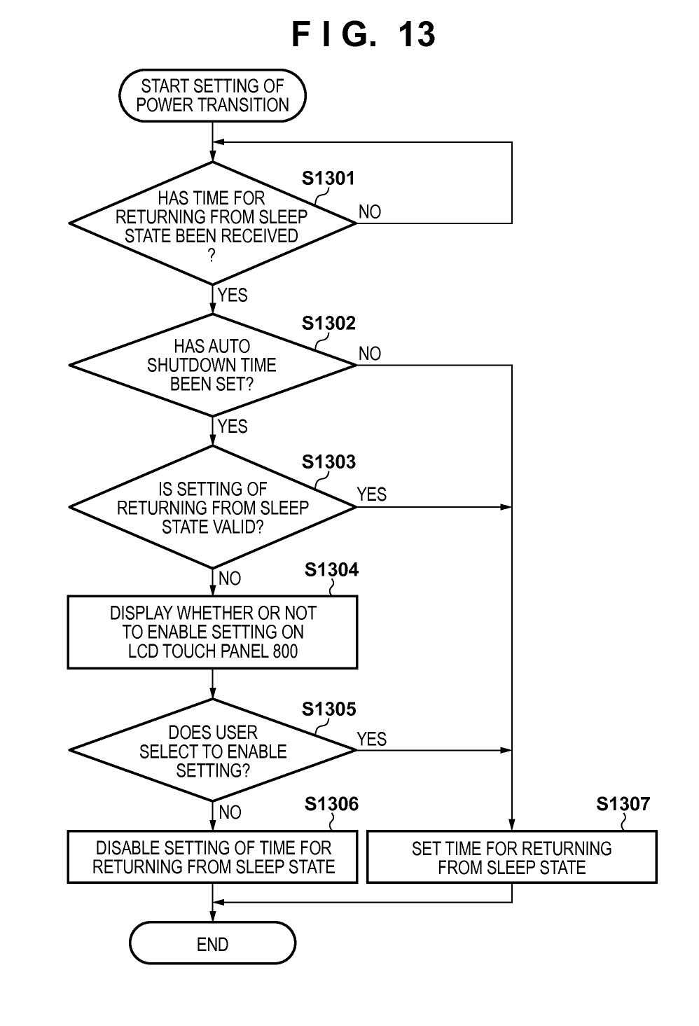

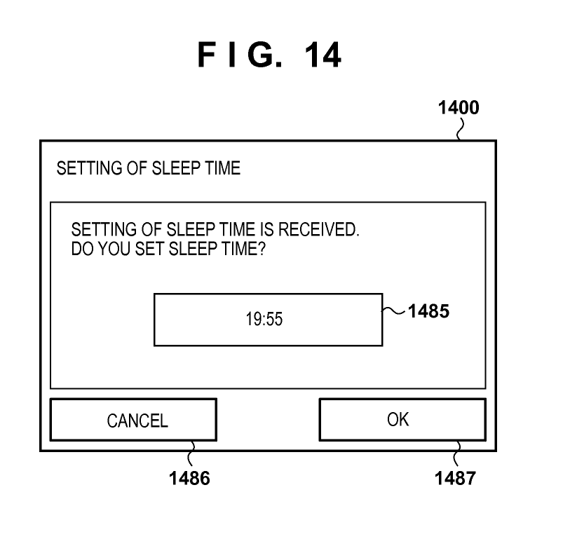

In the present embodiment, when state transition time is tried to be newly set immediately before the originally set state transition time, a field for allowing the user to input whether to enable or disable the setting is displayed and whether to enable or disable the additional setting is determined according to the input. The third embodiment will be described below using FIG. 13 and FIG. 14.

FIG. 14 is a flowchart for explaining a control method for the image forming apparatus according to the present embodiment. A flowchart for the case where waste of power is prevented when state transition time is newly set immediately before the originally set state transition time will be described below. In this figure, it is judged whether or not to set the time for returning from the sleep state by notifying the user and receiving the input. Because steps S1301 to S1303 of FIG. 14 are substantially the same as S1101 to S1103 in the flowchart of FIG. 11, only a difference will be described.

It is judged whether or not the received time for returning from the sleep state is valid, that is, included in the period before termination (S1303), and if the received time for returning from the sleep state is not valid, that is, included in the period before termination, a user interface screen 1400 (FIG. 14) for allowing the user to input whether to enable or disable the setting is displayed on the LCD touch panel 200 (S1304). If there is input on the screen, it is determined whether or not the user selects to enable the setting (OK button 1487) (S1305) and if the user selects to enable the setting, the time for returning from the sleep state is set (S1307). If the user does not select to enable the setting, that is, the user selects a cancel button 1486, the setting of the time for returning from the sleep state is ignored and disabled (S1306). On the other hand, if the time for returning from the sleep state is not included in the period before termination, the received time for returning from the sleep state is set (S1307).

FIG. 14 illustrates screen display for explaining a display method for the image forming apparatus according to the present embodiment. FIG. 14 illustrates an example of UI 1400 displayed in S1304 of the flowchart of FIG. 13. The user interface 1400 displayed on the LCD touch panel 200 includes a message for encouraging the user to input confirmation of the setting of the time for returning from the sleep state, and a notification field 1485 for notifying the user of the time, the OK button 1487 to be depressed when the user approves the setting, and the cancel button 1486 to be depressed when the setting is disabled. The user depresses the OK button 1487 when selecting to enable the setting, and depresses the cancel button 1486 when not selecting to enable the setting.

As described above, even if it is preferable to ignore the time for returning from the sleep state taking into account relationship between the time for returning from the sleep state and the auto shutdown time, in the present embodiment, by encouraging the user to confirm the time for returning from the sleep state, it is possible to provide options as to whether or not to enable the setting.

### Fourth Embodiment

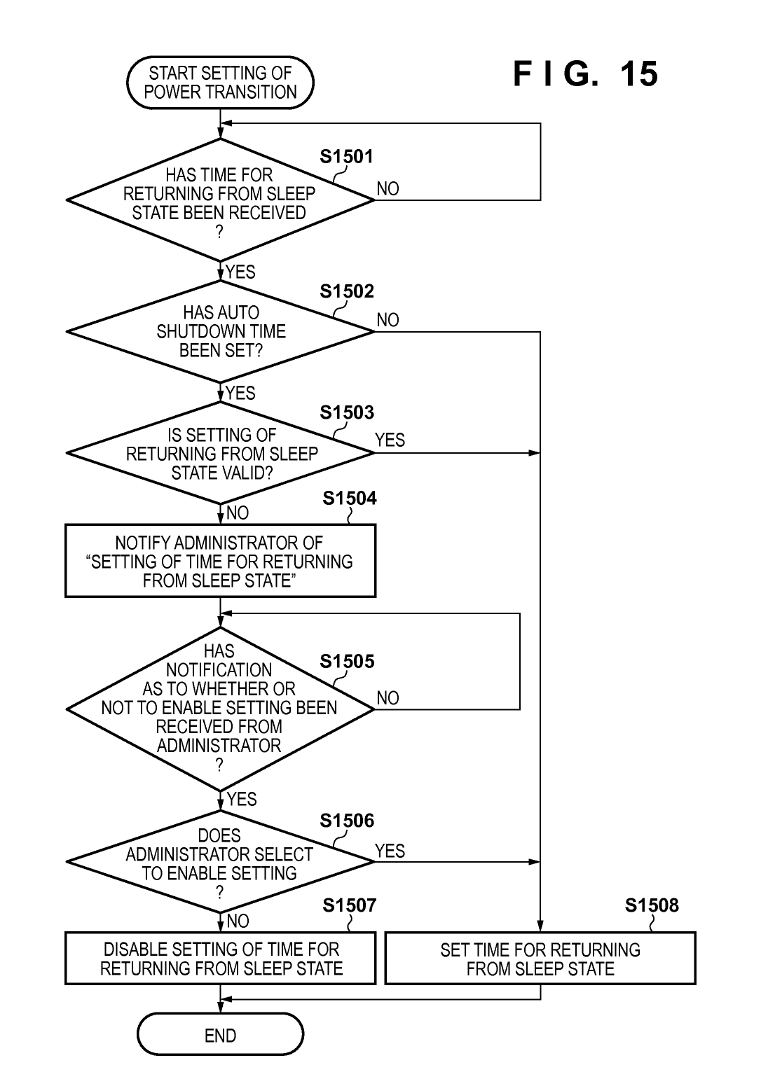

In the present embodiment, when state transition time is tried to be newly set immediately before the originally set state transition time, an administrator/server is allowed to input whether or not to enable the setting via the network, and whether or not to enable/disable the additional setting is determined according to the input. The fourth embodiment will be described below using FIG. 15. In this example, the confirmation in the third embodiment is performed by the administrator in place of the user. The fourth embodiment is different from the third embodiment in that the administrator is not always near the image forming apparatus 101.

FIG. 15 is a flowchart for explaining a control method for the image forming apparatus according to the present embodiment. A flowchart for the case where waste of power is prevented when state transition time is newly set immediately before the originally set state transition time will be described below. In the present figure, it is judged whether or not to set the received time for returning from the sleep state by notifying the administrator or the server of reception of the time for returning from the sleep state by email, or the like to allow the administrator or the server to respond. Because FIG. 15 is substantially the same as the flowchart of FIG. 11, the steps after S1503, which is different from the flowchart of FIG. 11 will be described.

It is judged whether or not the received time for returning from the sleep state is included in the period before termination (S1503). If the received time for returning from the sleep state is included in the period before termination, the computer 109 is notified of the received time for returning from the sleep state via the LAN 108 (S1504). The notification to the computer 109 is notification to the administrator, and, for example, as in the third embodiment, the user interface may be displayed at a terminal of the computer 109 or email may be distributed to a mailbox of the administrator. The apparatus waits for notification as to whether to enable or disable the received time for returning from the sleep state from the computer 109 (S1505), and if there is notification, the response from the administrator is determined (S1506). If the administrator selects to enable the setting, the time for returning from the sleep state is set (S1508). On the other hand, if the administrator selects to disable the setting, the setting of the time for returning from the sleep state is ignored and disabled (S1507).

According to the above procedure, even if the setting of the time for returning from the sleep state is setting which will waste power, it is possible to provide to the administrator options as to whether to enable or disable the setting.

### Fifth Embodiment

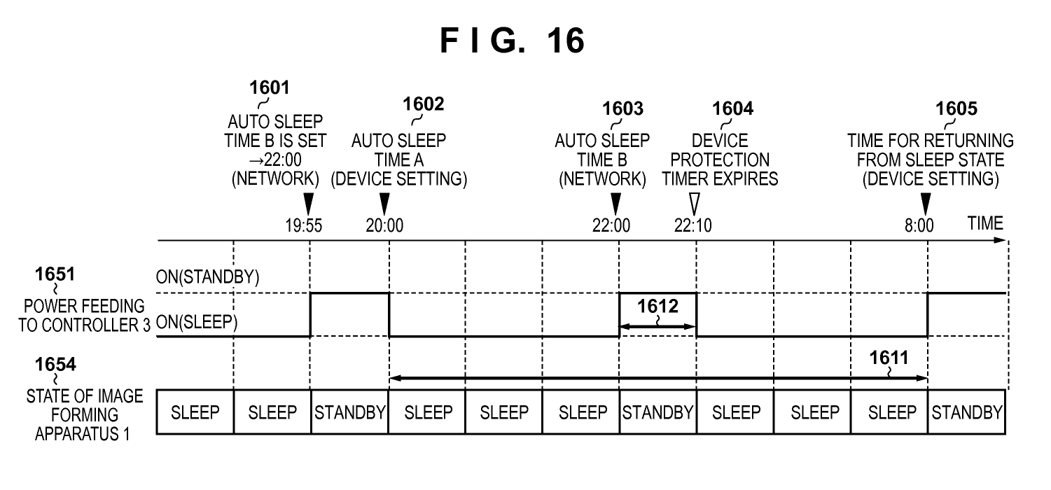

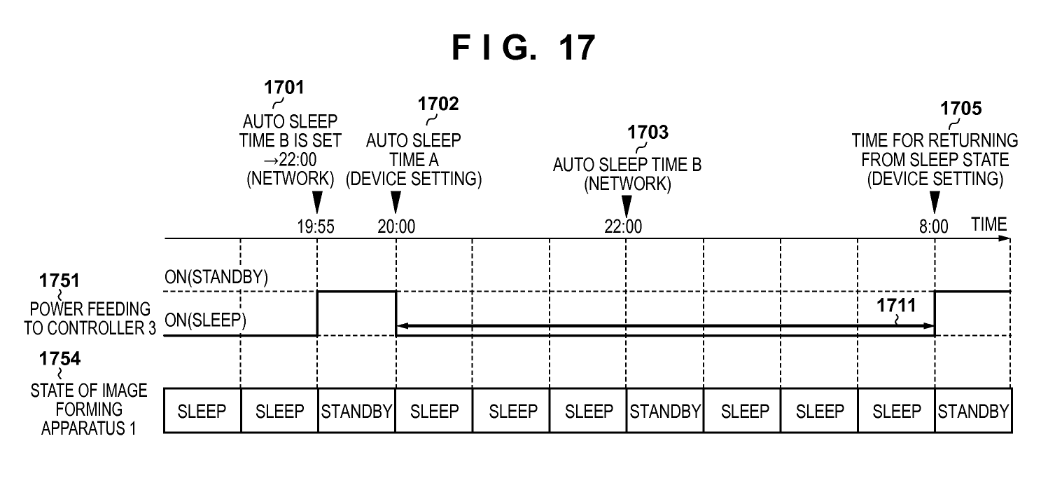

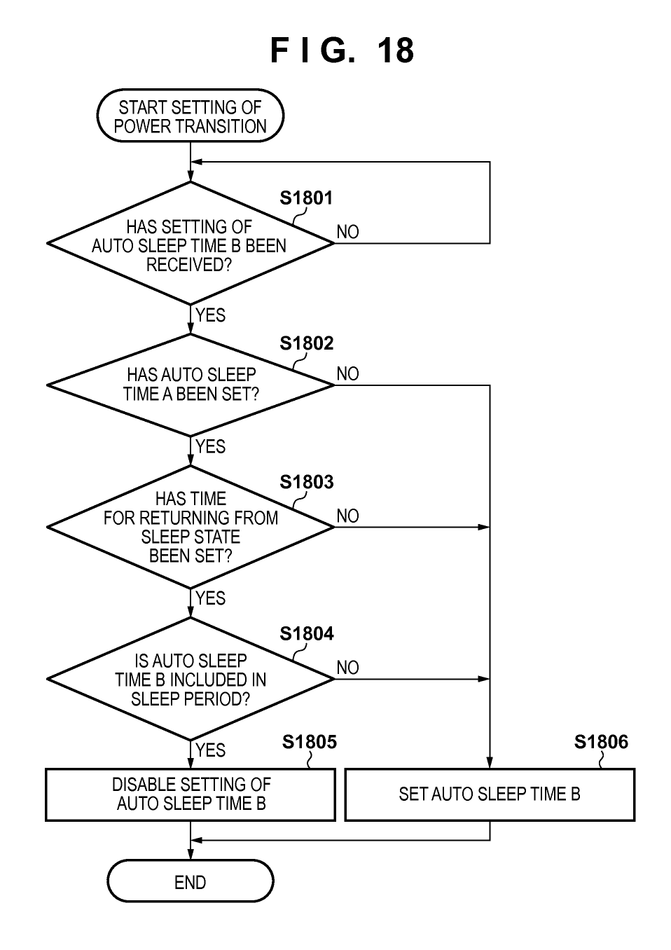

In the present embodiment, when state transition time is set during a sleep period from the set auto sleep time until the time for returning from the sleep state, the additional setting is disabled according to conditions. The fifth embodiment will be described below using FIG. 16, FIG. 17 and FIG. 18. FIG. 16 is a timing chart for explaining the conventional control method. An example where power is wasted when state transition time, that is, sleep time in FIG. 16 is set during the sleep period from the auto sleep time until the time for returning from the sleep state will be described below.

The ordinate indicates power feeding 1651 of the controller 103 and a state 1654 of the image forming apparatus 101. The power feeding 1651 of the controller 103 indicates two states of ON during the standby state (also referred to as a standby state), and ON during the sleep state (also referred to as a sleep state).

The abscissa indicates time. A black triangle indicates an event designated by the user, and a white triangle indicates an event designated by the image forming apparatus.

Auto sleep time A (1602) and time for returning from the sleep state (1605) are set by the user in advance to the image forming apparatus 101. Auto sleep time B (1603) is set via the network, which will be described in the present embodiment. The auto sleep time A (1602), the auto sleep time B (1603) and the time for returning from the sleep state (1605) can be set so as to exist together in the image forming apparatus 101. An example of problems in setting of the image forming apparatus 101 will be described according to the temporal axis using the above.

At 19:55, the image forming apparatus 101 is notified to set the auto sleep time B at 22:00 via the LAN 108 (1601). By this means, the image forming apparatus 101 makes the power feeding 1651 of the controller 103 transit from the sleep state to the standby state. At this time, 22:00 is set to the alarm service as the auto sleep time B (1603). The state transitions to the sleep state at 20:00 which is the auto sleep time A 1602 set in advance by the user to the image forming apparatus 101. By this means, the image forming apparatus 101 makes the power feeding 751 of the controller 103 transit from the standby state to the sleep state.

When it is 22:00 which is the auto sleep time B (1603), the image forming apparatus 101 makes the power feeding 1651 of the controller 103 transit from the sleep state to the standby state by the set alarm service. At the same time, the image forming apparatus 101 tries to make the power feeding 1651 transit to the sleep state by the setting of the auto sleep time B. However, once the state returns to the standby state, a device protection timer works. Therefore, the image forming apparatus 101 waits for expiration of the device protection timer until 22:10 (1604), and makes the power feeding 1651 of the controller 103 transit from the standby state to the sleep state at 22:10. At 8:00, the image forming apparatus 101 returns the power feeding 1651 of the controller 103 from the sleep state to the standby state by the time for returning from the sleep state 1605 set in advance by the user to the image forming apparatus 101.

As described above, the image forming apparatus 101 understands from the setting that the user rarely uses the apparatus during a period 1611 from the auto sleep time A (1602) until the time for returning from the sleep state 1605. Nevertheless, because the image forming apparatus 101 makes the power feeding 1651 of the controller 103 transit to the standby state during the period 1612 from the auto sleep time B (1603) until the expiration of the device protection timer 1604, power is wasted during this period.

FIG. 17 is a timing chart for explaining a control method for the image forming apparatus according to the present embodiment. An example where waste of power is prevented when state transition time is set during a sleep period from the auto sleep time until the time for returning from the sleep state will be described below. The explanation as to the ordinate and the abscissa is the same as that for FIG. 16. An embodiment of setting of the image forming apparatus will be described according to the temporal axis using the above.

At 19:55, the image forming apparatus 101 is notified to set the auto sleep time B (1703) at 22:00 via the LAN 108 (1701). By this means, the image forming apparatus 101 makes the power feeding 1751 of the controller 103 transit from the sleep state to the standby state. At this time, if 22:00 which is the auto sleep time B (1703) is included in the period (1711) from 22:00 which is the auto sleep time A (1702) until 8:00 which is the time for returning from the sleep state 1705, the auto sleep time B (1703) is not set.

As described above, the image forming apparatus 101 does not perform power feeding (1751) of the controller 103 during the period (1711) from the auto sleep time A (1702) until the time for returning from the sleep state (1705), so that it is possible to reduce power consumption. That is, if the designated auto sleep time is within the period of the sleep state, the designated auto sleep time is ignored and disabled. On the other hand, if the set auto sleep time is between the newly designated auto sleep time and the time for returning from the sleep state, the newly designated auto sleep time may be set, and the set auto sleep time may be disabled.

FIG. 18 is a flowchart for explaining a control method for the image forming apparatus according to the present embodiment. A flowchart for the case where waste of power is prevented when state transition time is newly set during a sleep period from the auto sleep time until the time for returning from the sleep state will be described below.

The image forming apparatus 101 judges whether or not the setting of the auto sleep time B has been received (S1801), and, if the setting has been received, the flow proceeds to the subsequent processing. Subsequently, it is determined whether or not the auto sleep time A is set (S1802). If the auto sleep time A is not set, the newly designated auto sleep time B is set (S1806). When the auto sleep time A has been set, the flow proceeds to the subsequent processing. It is then judged whether or not the time for returning from the sleep state has been set (S1803). If the time for returning from the sleep state has not been set, the auto sleep time B is set (S1806). If the time for returning from the sleep state has been set, the flow proceeds to the subsequent processing.

Subsequently, it is determined whether or not the newly designated auto sleep time is within a period of the sleep state (S1804). That is, it is determined whether or not the newly designated auto sleep time B is within a sleep period from the set auto sleep time A until the time for returning from the sleep state (S1804). If the newly designated auto sleep time is not set within the sleep period, the auto sleep time B is set (S1806). If the auto sleep time B is set within the sleep period, the setting of the auto sleep time B is ignored and disabled (S1805).

As with the flowcharts of the third and the fourth embodiments, when the setting is disabled, a fact that the setting is disabled may be displayed on the LCD touch panel 200, or the server or the administrator may be notified of the fact that the setting is disabled via the network.

Further, it is also possible to store the setting of the auto sleep time B outside the image forming apparatus and use the stored setting when the auto sleep time A or the time for returning from the sleep state is changed. If the setting of the auto sleep time B outside the image forming apparatus is not within a period from the auto sleep time A until the time for returning from the sleep state, the stored setting may be reset to a real time clock (RTC).

Further, as the specific determination in step S1804, the setting of the auto sleep time set within the sleep period may be disabled in either case of a case where the newly designated auto sleep time B is within the sleep period from the set auto sleep time A until the time for returning from the sleep state, or a case where the set auto sleep time A is within the sleep period from the newly designated auto sleep time B until the set time for returning from the sleep state. In the former case, the auto sleep time B is disabled, and in the latter case, the auto sleep time A is disabled.

According to the present embodiment, it is possible to prevent the state from returning from the sleep state during the sleep period in order to transition to the sleep state, so that it is possible to reduce power consumption.

In the above-described all embodiments, it is determined whether or not conditions that power consumption increases occur even when the image forming apparatus is not utilized based on transition of the set power state and its timing, and transition of the newly set power state and its timing. If it is determined that such conditions will occur, the new setting is ignored or the setting which has been set is disabled. More specifically, if it is determined that power consumption will increase as a result of returning from the sleep state to the normal state, setting for returning from the sleep state to the normal state is disabled. By this means, waste of power is prevented.

Each step of the present invention can be realized by executing software (programs) acquired through the network or various types of storage media at a processing apparatus (a CPU, a processor) of a personal computer (computer), or the like.

The present invention is not limited to the above-described embodiments, and various modifications (including organic combination of the embodiments) are possible based on the gist of the present invention, and such modification is not excluded from the scope of the present invention.

### Other Embodiments

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2014-138020, filed Jul. 3, 2014 which is hereby incorporated by reference herein in its entirety.

1. An image forming apparatus comprising:
a power control unit that controls power supply to be at any of a first power state, a second power state in which power consumption is lower than in the first power state, and a third power state in which power consumption is lower than in the second power state;
a setting unit that sets a timing for transition to any of the first power state, the second power state and the third power state; and
a holding unit that holds the transition to the power state and the timing set by the setting unit,
wherein the power control unit controls power supply according to the transition to the power state and the timing held by the holding unit, and
the setting unit determines whether or not power consumption increases in a case where the transition to the power state and the timing set by the setting unit is additionally set to the transition to the power state and the timing held by the holding unit, and, if the setting unit determines that the power consumption increases, the holding unit does not hold the transition to the power state and the timing to be additionally set, while if the setting unit determines that the power consumption does not increase, the holding unit holds the transition to the power state and the timing to be additionally set.

2. The image forming apparatus according to claim 1, wherein the setting unit sets a first timing for transition to the first power state, and if the holding unit holds setting for transition to the third power state at a timing within a predetermined period from the first timing, the setting unit determines that the power consumption increases.

3. The image forming apparatus according to claim 2, wherein the predetermined period is a period required for the image forming apparatus to transition from the second power state to the first power state.

4. The image forming apparatus according to claim 2, wherein a longest period among periods during which devices of the image forming apparatus have been put into a usable state since power was supplied to the devices, is used as the predetermined period.

5. The image forming apparatus according to claim 1, wherein in a case where the setting unit determines that the power consumption increases, a display unit displays that the transition to the power state and the timing to be additionally set are not held in the holding unit.

6. The image forming apparatus according to claim 1, wherein in a case where the setting unit determines that the power consumption increases, a display unit displays user interface for allowing input of an instruction as to whether or not to hold the transition to the power state and the timing to be additionally set in the holding unit, and, if an instruction not to hold the transition to the power state and the timing to be additionally set is input, the transition to the power state and the timing to be additionally set are not held in the holding unit.

7. The image forming apparatus according to claim 1, wherein in a case where the setting unit determines that the power consumption increases, the setting unit notifies an external apparatus of the transition to the power state and the timing to be additionally set, and, according to an instruction in response to the notification, in a case where an instruction not to hold the transition to the power state and the timing to be additionally set is received, the transition to the power state and the timing to be additionally set are not held in the holding unit.

8. The image forming apparatus according to claim 1, wherein in a case where a second timing for transition to the second power state and a third timing for transition to the first power state after the second timing are held in the holding unit, and a timing for transition to the second power state before the third timing is set by the setting unit, the setting unit disables transition to the second power state at a later timing, and the holding unit holds earlier transition to the second power state.

9. The image forming apparatus according to claim 1, wherein in a case where a second timing for transition to the second power state and a third timing for transition to the first power state after the second timing are held in the holding unit, and a fourth timing for transition to the second power state between the second timing and the third timing is set by the setting unit, the holding unit does not hold transition to the second power state at the fourth timing.

10. The image forming apparatus according to claim 1, wherein the first power state is a standby state in which power is supplied to the whole apparatus, the second power state is a sleep state in which power is supplied to part of the apparatus, and the third power state is a shutdown state in which power supply to the apparatus is stopped.

11. An image forming apparatus comprising:
a power control unit that controls power supply to be at any of a first power state, a second power state in which power consumption is lower than in the first power state, and a third power state in which power consumption is lower than in the second power state;
a setting unit that sets a timing for transition to any of the first power state, the second power state and the third power state; and
a holding unit that holds the transition to the power state and the timing set by the setting unit,
wherein the power control unit controls power supply according to the transition to the power state and the timing held by the holding unit, and
in a case where a timing for transition to the third power state is held by the holding unit, a timing for transition to the first power state is newly set by the setting unit, and the timing for transition to the first power state is between the timing for transition to the third power state and a timing earlier than the timing for transition to the first power state by a predetermined period, the newly set timing for transition to the first power state is not held by the holding unit.

12. An image forming apparatus comprising:
a power control unit that controls power supply to be at any of a first power state, a second power state in which power consumption is lower than in the first power state, and a third power state in which power consumption is lower than in the second power state,
a setting unit that sets a timing for transition to any of the first power state, the second power state and the third power state; and
a holding unit that holds the transition to the power state and the timing set by the setting unit,
wherein the power control unit controls power supply according to the transition to the power state and the timing held by the holding unit, and
in a case where a timing for transition to the second power state and a timing for transition to the first power state after the timing for transition to the second power state are held by the holding unit, and transition to the second power state is set between the held timing for transition to the second power state and timing for transition to the first power state by the setting unit, the transition to the second power state and the timing are not held by the holding unit.

13. A control method for an image forming apparatus, the image forming apparatus comprising:
a power control unit that controls power supply to be at any of a first power state, a second power state in which power consumption is lower than in the first power state, and a third power state in which power consumption is lower than in the second power state;
a setting unit that sets a timing for transition to any of the first power state, the second power state and the third power state; and
a holding unit that holds the transition to the power state and the timing set by the setting unit,
the control method comprising:
controlling power supply according to the transition to the power state and the timing held by the holding unit; and
determining whether or not power consumption increases in a case where the transition to the power state and the timing set by the setting unit is additionally set to the transition to the power state and the timing held by the holding unit, and, if it is determined that the power consumption increases, not holding the transition to the power state and the timing to be additionally set in the holding unit, while if it is determined that the power consumption does not increase, holding the transition to the power state and the timing to be additionally set in the holding unit.

14. A control method for an image forming apparatus, the image forming apparatus comprising:
a power control unit that controls power supply to be at any of a first power state, a second power state in which power consumption is lower than in the first power state, and a third power state in which power consumption is lower than in the second power state;
a setting unit that sets a timing for transition to any of the first power state, the second power state and the third power state; and
a holding unit that holds the transition to the power state and the timing set by the setting unit,
the control method comprising:
controlling power supply according to the transition to the power state and the timing held by the holding unit; and
if a timing for transition to the third power state is held in the holding unit, a timing for transition to the first power state is newly set by the setting unit, and the timing for transition to the first power state is between the timing for transition to the third power state and a timing earlier than the timing for transition to the first power state by a predetermined period, not holding the newly set timing for transition to the first power state in the holding unit.

15. A control method for an image forming apparatus, the image forming apparatus comprising:
a power control unit that controls power supply to be at any of a first power state, a second power state in which power consumption is lower than in the first power state, and a third power state in which power consumption is lower than in the second power state;
a setting unit that sets a timing for transition to any of the first power state, the second power state and the third power state; and
a holding unit that holds the transition to the power state and the timing set by the setting unit,
the control method comprising:
controlling power supply according to the transition to the power state and the timing held by the holding unit; and
if a timing for transition to the second power state and a timing for transition to the first power state after the timing for transition to the second power state are held by the holding unit, and transition to the second power state is set between the held timing for transition to the second power state and the timing for transition to the first power state by the setting unit, not holding the transition to the second power state and the timing in the holding unit.

16. A non-transitory computer readable medium which has stored therein a program for causing a computer to function as an image forming apparatus, said
image forming apparatus comprising:
a power control unit that controls power supply to be at any of a first power state, a second power state in which power consumption is lower than in the first power state, and a third power state in which power consumption is lower than in the second power state;
a setting unit that sets a timing for transition to any of the first power state, the second power state and the third power state; and
a holding unit that holds the transition to the power state and the timing set by the setting unit,
wherein the power control unit controls power supply according to the transition to the power state and the timing held by the holding unit, and
the setting unit determines whether or not power consumption increases in a case where the transition to the power state and the timing set by the setting unit is additionally set to the transition to the power state and the timing held by the holding unit, and, if the setting unit determines that the power consumption increases, the holding unit does not hold the transition to the power state and the timing to be additionally set, while if the setting unit determines that the power consumption does not increase, the holding unit holds the transition to the power state and the timing to be additionally set.

17. A non-transitory computer readable medium which has stored therein a program for causing a computer to function as an image forming apparatus,
said image forming apparatus comprising:
a power control unit that controls power supply to be at any of a first power state, a second power state in which power consumption is lower than in the first power state, and a third power state in which power consumption is lower than in the second power state;
a setting unit that sets a timing for transition to any of the first power state, the second power state and the third power state; and
a holding unit that holds the transition to the power state and the timing set by the setting unit,
wherein the power control unit controls power supply according to the transition to the power state and the timing held by the holding unit, and
in a case where a timing for transition to the third power state is held by the holding unit, a timing for transition to the first power state is newly set by the setting unit, and the timing for transition to the first power state is between the timing for transition to the third power state and a timing earlier than the timing for transition to the first power state by a predetermined period, the newly set timing for transition to the first power state is not held by the holding unit.

18. A non-transitory computer readable medium which has stored therein a program for causing a computer to function as an image forming apparatus
said image forming apparatus comprising:
a power control unit that controls power supply to be at any of a first power state, a second power state in which power consumption is lower than in the first power state, and a third power state in which power consumption is lower than in the second power state,
a setting unit that sets a timing for transition to any of the first power state, the second power state and the third power state; and
a holding unit that holds the transition to the power state and the timing set by the setting unit,
wherein the power control unit controls power supply according to the transition to the power state and the timing held by the holding unit, and
in a case where a timing for transition to the second power state and a timing for transition to the first power state after the timing for transition to the second power state are held by the holding unit, and transition to the second power state is set between the held timing for transition to the second power state and timing for transition to the first power state by the setting unit, the transition to the second power state and the timing are not held by the holding unit.
